(19) United States
(12) Patent Application Publication
(10) Pub. No.: US 2003/0025256 A1
(43) Pub. Date: Feb. 6, 2003

(54) Spring anchor clip for seating and furniture frames

(76) Inventor: Reinhard M. Roick, Burks Falls (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 10/096,618

(22) Filed: Mar. 14, 2002

(30) Foreign Application Priority Data
Jul. 31, 2001 (CA) 2,354,502

(51) Int. Cl. F16F 1/00

(52) U.S. Cl. 267/142

(57) ABSTRACT

A support frame assembly for use in the manufacture of furniture, including a pair of frame members, one or more support springs and spring anchors for coupling the springs to the frames. The springs function as a load absorbing resilient base for padding and/or cushioning used in the seating construction. The spring anchors are used in securing each end of the springs under tension to a frame member. Each spring anchor is formed as a generally P-shaped clip, having a flange portion which merges into and is integral with a loop portion which defines a bore extending therethrough. The loop portion is formed as a continuous fully closed loop to provide the anchor clip with increased structural integrity and to better resist deformation upon the application of load forces to the spring. The flange portion is secured directly to the frame member in a position so that the loop portion projects forwardly past an edge of the frame member closest towards the other opposing frame member.

### SCOPE OF THE INVENTION

This invention relates generally to seating and furniture frames and more particularly, to a seating or furniture frame assembly in which the ends of support springs are held under tension by spring anchors which have been coupled to individual frame members by mechanical fasteners, glues and/or by welding.

### BACKGROUND OF THE INVENTION

In the construction of chairs, couches and other types of seating and furniture, no-sag, coil or leaf-type furniture springs are used to provide cushion support. The springs are frequently secured under tension to wooden or metal frame members by the use of plastic anchor clips which have been nailed, stapled or otherwise secured directly to the frame members in a friction fit. The anchor clips are constructed so as to retain one end of the spring, thereby coupling it to the frame member.

U.S. Pat. No. 5,909,198 to Roick, which issued Apr. 25, 1995 discloses a prior art anchor clip used in securing the ends of no-sag springs to metal frame members. The anchor clip disclosed in U.S. Pat. No. 5,909,198 is provided with a forwardly open slot which is adapted to engage a rearwardly extending flange on the frame member, and a rearwardly open slot or groove used to retain the end of the spring. The groove secures the end of the spring in the assembly of the seating frame, whereby an endmost coil of the spring is fitted into the rearwardly opening slot. Once so positioned, the end of the spring is retained by the anchor clip against forward movement by both the tension applied by the resiliency of the spring, and any tensioning load forces applied to the spring when a user sits on the furniture.

A difficulty exists with conventional anchor clips in that they are typically formed with a bulky construction. In particular, to avoid the deformation and failure of the anchor clip when load forces are applied to the springs, it is necessary to manufacture the anchor clips with a sufficiently large size and thickness to withstand the stresses applied by heavier users. In addition to increasing material costs, the larger size of conventional anchor clips is disadvantageous in that once secured in position on a frame member, the anchor clips present pronounced protuberances on the seating frame members to which they are attached, often projecting 1.25 cm or more above the frame surface. This in turn necessitates that furniture be constructed with additional layers of foam or cloth padding covering the anchor clips, to prevent users from experiencing discomfort as a result of feeling the anchor clips when seated.

### SUMMARY OF THE INVENTION

It is an object of the present invention to at least partially overcome the disadvantages of the prior art by providing a seating or furniture frame assembly in which the ends of the seat springs are coupled to frame members by comparably smaller spring anchors or clips.

Another object of the invention is to provide a robust spring anchor clip for attachment to a metal, plastic or wooden furniture frame and which when secured in place, projects a distance of 0.75 cm or less above the surface of the frame.

Another object of the invention is to provide a seating or furniture frame assembly in which generally P-shaped spring anchors are used to secure the opposite ends of a support spring in a position under tension, substantially spanning the distance between a pair of two opposing frame members.

Another object is to provide an economical and easily manufactured P-shaped spring anchor for use in a seating frame assembly, and which is constructed with a profile selected to enable its concealment with a minimum thickness of covering foam and/or padding.

Another object of the invention is to provide a spring anchor clip for a seating assembly to be used in furniture, aircraft, rail coach and/or vehicle applications, and which permits comparably shorter seating springs to be used.

A further object of the invention is to provide a compact spring anchor as part of a frame assembly for couches, chairs, lounges and other types of seating, and which possesses increased strength and resistance to deformation under load forces.

Another object of the invention is to provide an anchor clip for securing the ends of a no-sag spring under tension in a seating frame, and which includes a continuous loop portion which defines a laterally extending through-opening for receiving and fixedly retaining therein a laterally oriented end-most coil of the spring.

A further object of the invention is to provide an inexpensive and easily manufactured anchor clip for use in a seating frame and which is adapted to secure a no-sag, coil, elastomeric or other type of spring under loading forces of at least 26 kilograms, without significant deformation and/or failure.

In furtherance of at least some of the aforementioned objects, the invention provides a support frame assembly which is suitable for use in the manufacture of sofas, chairs, lounges and other furniture, as well as for seating used in aircraft, rail car, vehicle and other applications, and which is hereafter generally referred to as seating. The frame assembly includes at least one, and typically at least one pair of frame members, one or more support springs and spring anchors for coupling the springs to one or both frames.

The frame members are typically spaced from each other and provide the overall structural framework for the seating. Depending upon the intended seating application, the frame members may be formed from molded or extruded plastics, steel or other metal rails or tubes. In the case of furniture, however, in a simplified construction, the frame members are made of engineered or natural wood, and most preferably have a generally rectangular cross-sectional profile in a longitudinal direction.

The springs may be of numerous possible designs which are suited to function as a load absorbing resilient base for padding and/or cushioning used in the seating construction. Preferred types of springs to be used with the present invention include elastomeric straps, elongated no-sag springs, elongated coil springs, as well as combinations of springs and metal or plastic straps, in addition to other spring types suitable for use with furniture or other seating.

The spring anchors are used in securing one, and preferably both ends of each spring under tension to the opposing frame members. In particular, where two generally parallel spaced apart frame members are provided, aligned pairs of spring anchors, each coupled to a respective frame member, are used to secure the opposing ends of each spring in a tensioned configuration substantially spanning between the frame members. The spring anchors may be formed of plastics or metals through either molding, casting, or more preferably, as a plastic or aluminum extrusion.

Each spring anchor is formed as a generally P-shaped clip, characterized by a flange portion which merges into and is integral with a loop portion. The loop portion defines a bore or through-opening extending laterally at least partially, and more preferably wholly, through the anchor clip. In a most preferred construction, the loop portion is formed as a continuous or fully closed loop extending 360°, to provide the anchor clip with increased structural integrity and to better resist deformation upon the application of load forces by the spring.

The flange portion of the anchor is secured directly against one of the frame members by the use of a mechanical fastener, glues and/or welding. Suitable mechanical fasteners would include staples, nails, screws, bolts, rivets or the like which are used to physically couple the clip to a frame member. The spring anchor is most preferably coupled to a flat upper surface of the frame member in a position so that the loop portion extends both forwardly from a forward upper edge of the frame member which is spaced closest towards the other opposing frame member, and in an orientation with the loop portion curving downwardly therefrom. In this orientation, the anchor clip is thus positioned relative to the frame member so that the loop portion extends towards the direction of load forces applied by the spring, with the loop portion located forwardly a distance towards the opposing frame member.

To assist in the coupling of the spring end with an associated spring anchor, the springs may optionally be provided at each end with a rigid hook, keeper member or other catch device configured for insertion into the through-opening of the anchor clip. To couple the spring to a frame member, the spring end, hook or catch device is simply inserted laterally into, and more preferably through, the through-opening. Once so positioned, the resiliency of the spring secures the spring end to the anchor, thereby coupling it to the frame member.

Most preferably, the cross-sectional shape of the through-opening is selected to enable lateral sliding of the spring end through the opening when the spring is moved to an orientation which is not normally achieved during use of the seat, while preventing its return movement therethrough under normal rest and/or loading conditions. Where the spring is provided with a hooked or bent end, the through-opening of the anchor clip may be formed having an elongated or generally elliptical cross-sectional shape. It is to be appreciated, however, that the through-opening could be provided with a variety of cross-sectional shapes, including without limitation, a circular, irregular, polygonal or tear drop cross-sectional shape. Optionally, one or both of the outermost peripheral edges of the through-opening may be provided with a bevelled or inwardly sloping surface and which acts as a caming surface used to facilitate the initial insertion of the spring end through the anchor clip.

By providing a spring anchor which extends forwardly past the frame member to which it is secured, it is possible to utilize comparatively shorter springs. In addition to the cost savings achieved through the use of shorter springs, the reduction in the amount of necessary foam covering and in the spring material may also achieve a weight advantage over conventional seating frame assemblies. As such, a comparatively lighter seating assembly may be achieved which may prove advantageous, particularly where the seating frame is to be used in aircraft seating or other weight sensitive environments.

Accordingly in one aspect, the present invention resides in the combination of a furniture frame comprising a first frame member, a second frame member spaced forwardly a distance apart from the first frame member, an elongate spring extending in a longitudinal direction from a first end portion to a second end portion substantially between the first and second frame members, and a spring anchor for coupling the first end of the spring to the first frame member,

the anchor being secured to the first frame member and including a generally planar flange portion extending from a rearward end to a forward end spaced towards the second frame member, and a spring retaining loop portion at said forward end,

said loop portion including a laterally extending through-opening, the first end portion of the spring extending through the through-opening, and whereby the engagement of the first end portion of the spring with said loop portion substantially prevents the return movement of the first end portion outwardly therefrom.

In another aspect, the present invention resides in a spring anchor for use in securing a first end of a spring to a furniture frame member, the anchor comprising a generally P-shaped clip member including a flange portion having a forward end and a rearward end, and a spring retaining continuous loop portion integral with said forward end,

the rearward end including a planar lower surface adapted for juxtaposed contact with a mounting surface of said furniture frame,

said loop portion including a laterally extending through-opening sized to receive and retain the first end of the spring.

In a further aspect, the present invention resides in the combination of a seating frame member an elongate spring having a first end portion and a second end portion, and a spring anchor for securing the first end portion of the spring to the frame member,

the spring anchor comprising a generally P-shaped clip member including a generally planar flange portion having a forward end and a rearward end, and a spring retaining continuous loop portion disposed at said forward end, the loop portion being integrally formed with the flange portion and defining a through-opening extending therethrough sized to receive and retain the first end portion of the spring.

### BRIEF DESCRIPTION OF THE DRAWINGS

Further objects and advantages of the invention will appear from the following detailed description, taken together with the accompanying drawings in which:

FIG. 1 is a partial perspective top view of a furniture frame assembly in accordance with the present invention;

FIG. 2 is a cross-sectional view of the furniture frame assembly of FIG. 1 taken along lines 2-2;

FIG. 3 is an enlarged partial view of the left hand furniture frame shown in FIG. 2 showing a spring anchor secured thereto;

FIG. 4a shows an enlarged perspective view of the spring anchor for use with the furniture frame of FIG. 1;

FIG. 4b, 4c and 4d show respectively rearward end, forward end and top views of the spring anchor shown in FIG. 4a;

FIG. 5 shows a schematic side view of a spring anchor in accordance with a second embodiment of the invention;

FIG. 6 shows a schematic top view of the spring anchor of FIG. 5;

FIG. 7 shows a schematic side view of a spring anchor in accordance with a third embodiment of the invention;

FIG. 8 shows a schematic side view of a spring anchor in accordance with a fourth embodiment of the invention;

FIG. 9 shows a schematic top view of a collated strip of the spring anchors shown in FIG. 4, prior to attachment to a furniture frame; and

FIG. 10 shows a schematic top view of a spring anchor in accordance with a fifth embodiment of the invention, showing the retention of the spring end thereby.

### DETAILED DESCRIPTION OF THE PREFERRED EMBODIMENTS

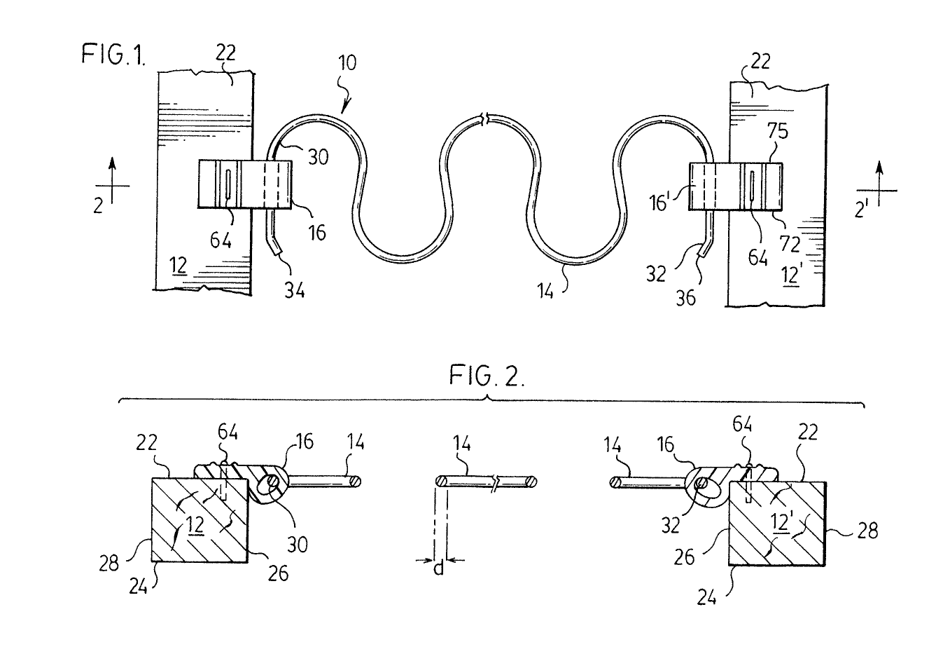

Reference is first made to FIGS. 1 and 2 which show part of a furniture frame assembly used in the manufacture of sofas, couches and chairs, generally indicated 10. The frame assembly 10 includes a pair of parallel spaced frame members 12,12′, a no-sag steel spring 14 and a pair of plastic spring anchors 16,16′. As will be described, the anchors 16,16′ are used to secure the spring 14 to the frame members 12,12′ under tension, with the spring 14 acting as a load absorbing resilient base for cushioning (not shown) used in the construction of the sofa or chair.

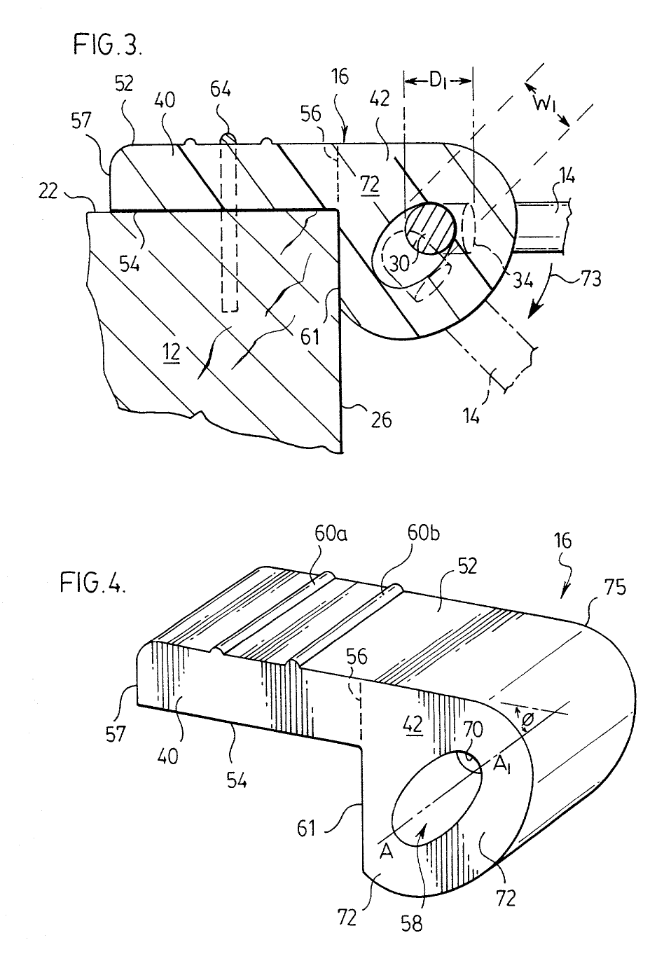

FIGS. 2 and 3 show best the frame members 12,12′ as providing the basic structural support for the frame assembly 10 and being formed from either engineered or natural wood. In the lateral view shown in FIG. 2, the frame members 12,12′ have a generally rectangular cross-sectional profile and each include parallel planar top and bottom surfaces 22,24 (FIG. 2), as well as planar parallel vertical forward and rearward side surfaces 26,28. Although not essential, the top surface 22 of the frame member 12 is most preferably provided in a substantially co-planer relationship with the top surface 22 of the frame member 12′. FIG. 2 shows best the surfaces 26,28 of each frame member 12,12′ as being oriented generally perpendicular to the top and bottom surfaces 22,24 with the forward surfaces 26 of frame members 12,12′ each facing towards the forward surface 26 of the other opposing frame member 12′,12, respectively.

FIGS. 1 and 2 show the metal no-sag spring 14 as being elongated in a longitudinal direction and secured under tension by the pair of spring anchors 16,16′ in a position substantially spanning between the two elongate and spaced apart frame members 12,12′. While a single spring 14 has been shown in FIGS. 1 and 2 for clarity, it is to be appreciated that the frame assembly 10 would typically incorporate a number of springs 14, each arranged and held in a generally parallel relationship by a corresponding number of pairs of anchors 16,16′, and having the identical construction to that shown. The no-sag spring 14 consists of a unitary piece of high strength steel having a cross-sectional diameter d (FIG. 2) and which is bent in a serpentine fashion. The bent spring 14 has a longitudinal length selected approximately equal to, and most preferably marginally less than the spacing between the frame member 12,12′ at the point where the spring 14 is to be used. The endmost coils or bends 30,32 at each opposing longitudinal end of the spring 14 extend in a generally lateral orientation to a respective endmost tip portion 34,36. The endmost tip portions 34,36 of each respective coil 30,32 are bent back towards the other opposing coil 32,30, respectively, in the form of a hook.

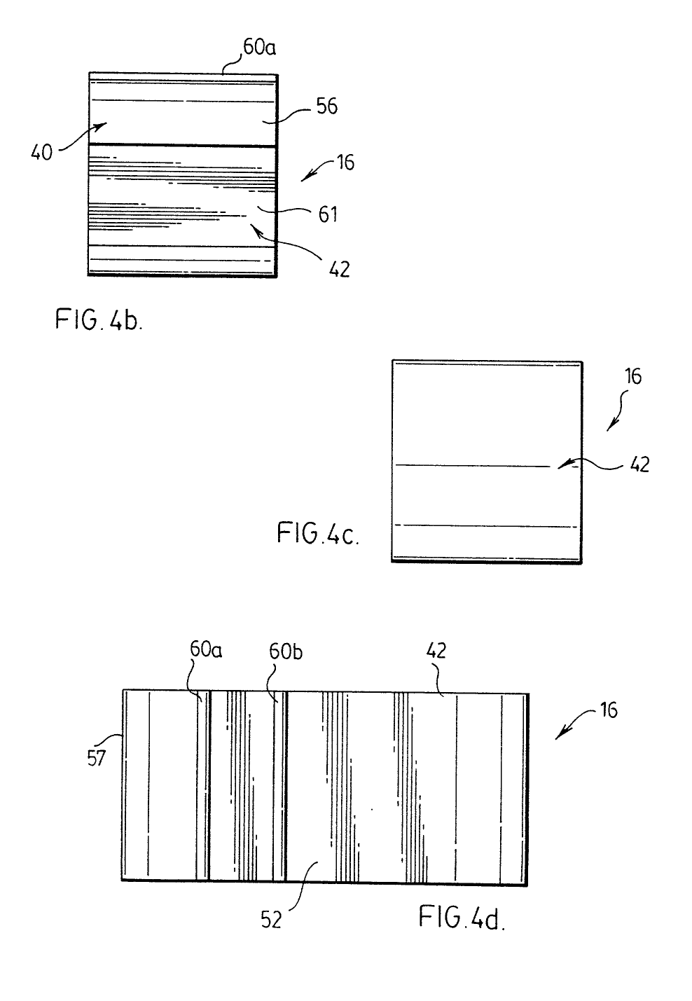

FIGS. 3 and 4a-d show best a single preferred spring anchor 16 for use with the present invention, the opposing anchor 16′ having the identical construction and as shown in FIG. 2, secured to the opposing frame member 12′ in a substantially mirror arrangement. The anchor 16 is formed as a unitary plastic extrusion, and in lateral profile appears generally P-shaped. In the orientation shown, the anchor 16 is elongated in the longitudinal direction and preferably has an overall longitudinal length of between 2 and 6 cm, and most preferably about 4 cm.

The anchor 16 includes a flattened rectangular flange portion 40 which is delineated by generally planar upper and lower horizontal surfaces 52,54. The flange portion 40 merges into and is integral with a spring retaining loop portion 42 at its forward end (delineated by phantom line 56 in FIG. 3). The flange portion 40 of the anchor 16 has a thickness between the surfaces 52,54 selected at between about 0.3 and 1 cm and more preferably about 0.6 cm. As will be described, the generally planar lower surface 54 permits its placement in direct juxtaposed contact with the upper top surface 22 of the frame member 12 in the positioning and securement of the anchor 16 to the frame member 12. The upper and lower surfaces 52,54 are of a sufficient lateral width as to provide a bearing surface, so that when the flange 40 is secured against the surface 22, the lateral width of the flange 40 prevents pivotal movement of the anchor clip 16 in the lateral direction. For most furniture applications, the clip flange 40 has a preferred overall lateral width of between about 1 and 4 cm, and more preferably about 2 cm, however, clips of differing sizes are also envisioned.

FIGS. 3, 4a and 4d illustrate the upper surface 52 as including a pair of parallel spaced, raised guide ribs 60a,60b spaced towards a rearward end 57 of the anchor clip 16. Although not essential, the guide ribs 60a,60b extend laterally across the upper surface 52 and are provided to assist the user in positioning a staple 64 (FIG. 3), or other mechanical fastener used to secure the anchor clip 16 in the desired position on the frame member 12.

FIG. 4a illustrates the loop portion 42 of the anchor clip 16 as extending 360° as a fully closed or continuous loop which defines a laterally extending through-opening 58 extending therethrough. As will be described, the through-opening 58 which extends through the anchor 16 is formed with a sufficient diameter to enable insertion of the spring end 30, therethrough. The loop portion 42 further includes a flat rearwardmost lower peripheral shoulder 61. The shoulder 61 extends vertically downward from the forward end 56 of the flange portion 40, in an orientation generally perpendicular to that of the planar bottom surface 54. As shown best in FIG. 3, the surface 54 and shoulder 61 are configured to enable the anchor 14 to be positioned in abutting contact with the respective top and forward side surfaces 22,26 of the frame member 12. It is to be appreciated that in this orientation the surface 54 and shoulder 61 act as perpendicular bearing contact surfaces between the anchor 16 and frame member 12, reducing the tendency of the anchor 16 to rock or pivot forwardly in the longitudinal direction relative to the frame member 12, when load forces are applied by the spring 14. The inventor has appreciated that providing the spring anchor 16 with a loop portion 42 which is formed as a continuous loop integral with a remainder of the anchor 16, permits the anchor 16 to be made smaller than conventional anchor clips, while still providing enhanced strength and resistance to deformation under spring loads.

Although not essential, the through-opening 58 most preferably extends completely through the loop portion 46 of the anchor 16. In its lateral direction, the cross-section of the through-opening 58 is provided with a generally elliptical shape which is elongated in the direction of axis A-A₁ (FIG. 4). The through-opening 58 is oriented with its axis of elongation A-A₁ inclined relative to the direction of load forces and the plane of the upper and lower flange surfaces 52,54 at an angle θ of between about 0 and 45°, preferably about 10° and 45°, and most preferably at about 30°. The elliptical cross-sectional shape of the through-opening 58 is formed with a length in the axial direction of axis A-A₁ selected to enable the hooked end 34 of the spring coil 30 to be slid laterally therethrough. Most preferably the length of the opening 58 along the axis A-A₁ (FIG. 4) is marginally greater than the maximum dimension D₁ (FIG. 3) between the rearward edge of the spring coil 30 and the endmost tip portion 34 (shown in phantom in FIG. 4). Although not essential, the through-opening 58 preferably has a width W₁ (FIG. 4) in a direction normal to the axis A-A which is marginally greater than the diameter d of the spring 14, but less than dimension D₁.

FIG. 3 shows best the positioning and securement of the anchor 16 to the frame 12. It is to be appreciated that although not essential, to minimize both the extent which the anchor clips 16 protrude above the frame members 12 and the thickness of covering foam or other padding layers necessary to conceal the presence of the anchors 16 from a user, the anchor clip 16 is preferably secured to the surface 22 of the frame member 16 with the loop portion 42 extending in a generally downward orientation in the manner shown in FIG. 3. In this orientation, the anchor 16 is positioned in the desired location with the lower planar surface 54 of the flange 40 directly overlying the top frame member surface 22. The rearward shoulder 61 is similarly moved rearwardly into juxtaposed contact with the adjacent portion of the inward facing vertical surface 26 of the frame member 12. A staple 64 is then driven vertically through the anchor flange 40 between the guide ribs 60a,60b so as to extend therethrough a sufficient distance into the frame member 12, mechanically securing the anchor 16 in place. In this configuration, the anchor 16 is secured to the frame member 12 so as to present the lowest possible profile projecting upwardly less than 1 cm above the surface 22. As a result, the anchor 16 does not present an uncomfortable protrusion which could otherwise be felt by a user. This, in turn, minimizes the amount of foam or padding material necessary to cover the anchor clip 16.

Following the securement of the anchor 16 to the frame member 12, the anchor 16′ is next secured to an opposing part of the frame member 12′ in a mirror orientation in the identical manner. It is to be appreciated that with the positioning of the anchor clips 16,16′, both looped portions 46 extend forwardly inward from the surfaces 26 of the respective frame members 12,12′ towards the other opposing frame member 12′,12. It is to be appreciated that this configuration advantageously permits springs 14 of comparatively shorter length to be used in the frame assembly 10, than compared to those used with conventional anchor clips which secure the ends of springs in a position vertically above a frame support.

FIG. 1 shows best the springs 14 having a length which, when tensioned, is slightly less than the innermost distance between the frame members 12,12′. To secure the spring 14 in place, the coil 30 is inserted through the through-opening 58 of the anchor 16 by orienting the hook 34 so that its maximum dimension D₁ is aligned with the axis A-A₁. The coil 30 is then slid laterally through the opening 58 to the position shown in FIG. 1, coupling the end of the spring 14 to the frame member 12. Following the insertion of the coil 30 through the anchor 16, the second other end coil 32 of the spring 14 is then secured to the opposing frame member 12′ by anchor 16′. To couple the end coil 32 of the spring 14 to the anchor 16′, the spring 14 is stretched by pulling longitudinally, and the hooked end 36 of the spring 14 is aligned with the axis A-A₁ of the through-opening 58 of anchor 16′. The coil 32 is then slid laterally through the opening 58 of anchor 16′ to the position shown in FIG. 1. The tensioning provided by the spring resiliency causes the end coils 30,32 to pull inwardly towards each other, sliding forwardly in the openings 58 of each respective anchor clips 16,16′ towards the other opposing frame member 12′,12. Upon sliding insertion of the spring coils 30,32 through the respective through-openings 58, the tension applied by the resiliency of the spring 14, causes the endmost coils 30,32 to move forwardly in the through-opening 58 and into engagement with the forwardmost curved bight 70 (FIG. 4) of each anchor 16,16′, respectively. Although not essential, for even distribution of load forces the radius of curvature of the forward bight 70 is preferably selected so as to substantially correspond with the radius of curvature of the spring coils 30,32 which are positioned therein.

As shown best in FIG. 3, under normal rest conditions, the resiliency of the spring 14 results in the hooked end 34 engaging a side 72 of the anchor 16 adjacent the bight 70, preventing the return movement of the coil 30 laterally outward from the through-opening 58. The engagement of the hooked end 34 with the side 72 thus acts to prevent the withdrawal of the spring 14 from the anchor 16 under non-loading conditions, as for example if the furniture is tilted or moved.

The application of load forces to the furniture results in the spring 14 deflecting downwardly in response to the weight of a user (not shown) thereon. Furthermore, because of the integral construction of the loop portion 42 and the flange portion 40, it has been found that load forces of lat least 26 kg, and most preferably upto 40 kg, may be applied by the spring 14, without failure or significant deformation of the anchor 16. Typically in use, the spring deflects downwardly in the direction of arrow 73 to the position shown in phantom in FIG. 3. It is to be appreciated that the downward deflection of the spring 14 results in the coil 30 and hooked end 34 pivoting relative to the through-opening 58. Furthermore, because of the elliptical cross-sectional shape of the through-opening 58, when the spring 14 is placed under load forces, the coil 30 and hooked end 34 typically achieve an orientation whereby the hooked end 34 extends forwardly downward in an orientation generally perpendicular to the axis A-A₁. It is to be appreciated that because the through-opening width W₁ in this direction isles than the dimension D₁, this orientation provides the maximum contact surface between the hooked end 34 and the side 72 of the anchor 16, further decreasing the likelihood that the spring coil 30 may inadvertently moved outwardly from the through-opening 58.

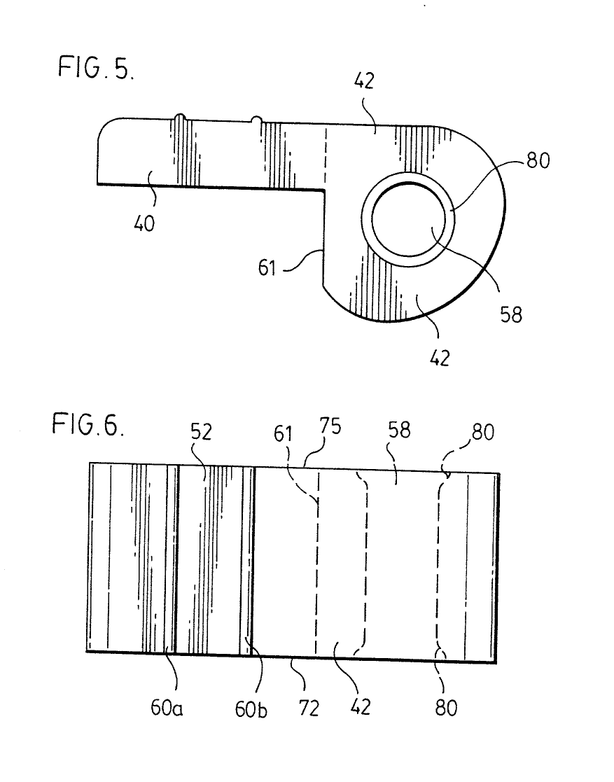

Although FIGS. 3 and 4a illustrate an anchor clip 16 having a through-opening 58 which is elliptical in lateral cross-section, the invention is not so limited. Other shaped openings may also be used and will now become apparent. By way of non-limiting example, FIGS. 5 to 8 show anchor clips 16 in accordance with alternate embodiments of the invention and in which like reference numerals are used to identify like elements. In FIG. 5, the anchor clip 16 is characterized by a through-opening 58 which is generally circular in lateral cross-section. The through-opening of FIG. 5 flairs outwardly into an increased diameter portion or bevelled surface adjacent each longitudinal side 72,75 of the anchor clip 16. It is to be appreciated that the anchors shown in FIGS. 5 through 8 would be secured to the frame members in essentially the identical manner as the anchor 16 which is illustrated in FIG. 3. The bevelled surface 80 of the through-opening 58 acts as a caming surface along which a hooked end 34 of the spring 16 may be slid to facilitate the insertion of the coil 30 through the anchor 16.

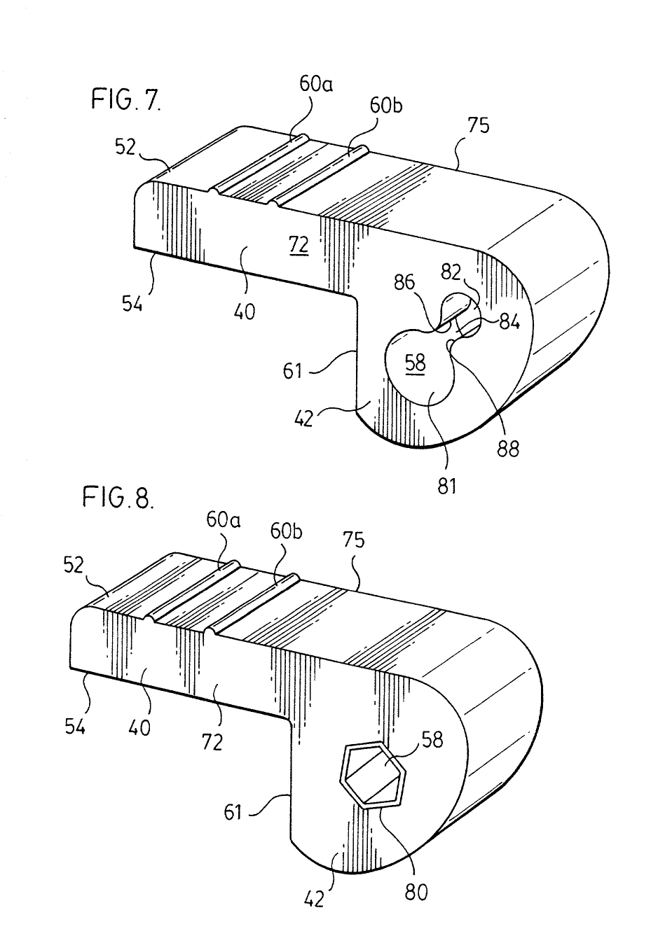

FIGS. 7 and 8 illustrate two alternate possible constructions for the spring anchor clip 16 wherein the through-opening 58 is provided with an irregular or polygonal shaped cross-sectional profile. In FIG. 7, the through-opening 58 includes an enlarged diameter portion 81 and a reduced diameter portion 82. The reduced diameter portion 82 has a diameter generally corresponding to the diameter d of the coil 30, and is delineated from the enlarged diameter portion 81 by an inwardly extending neck portion 84. The neck portion 84 is defined by a pair of resiliently deformable webs 86,88 which are spaced from each other by a distance which is selected to permit substantially one-way movement of the spring coil 30 (FIG. 1) from the enlarged diameter portion 81 therepast and into the reduced diameter portion 82.

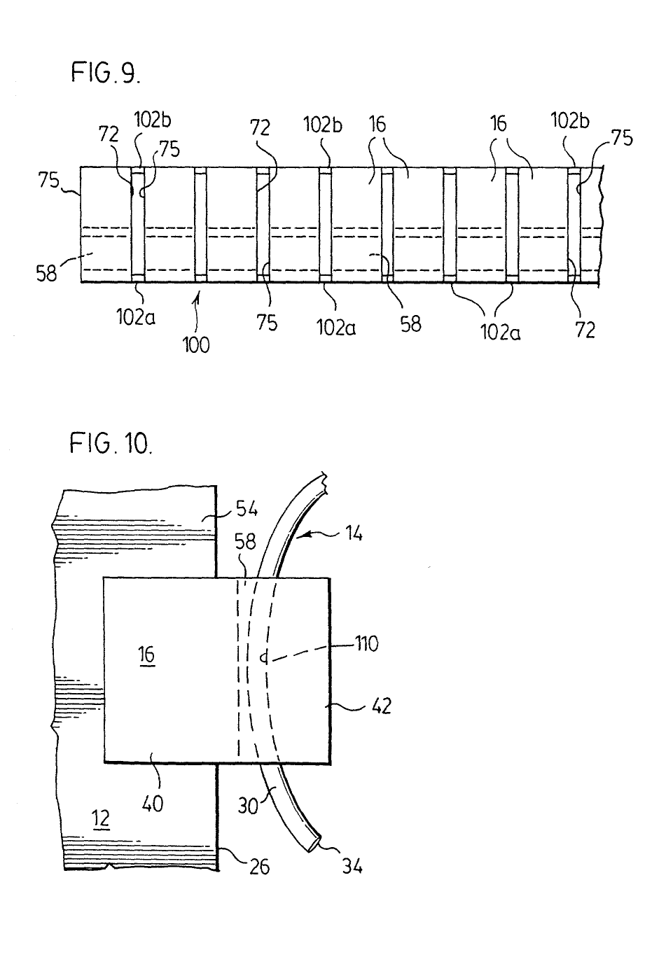

FIG. 9 shows best the spring anchors 16 as being provided as part of a collated strip 100 of anchors having the identical construction, and which are formed as an extruded strip. In the elongated strip 100, the longitudinal sides 72,75 of adjacent spring anchors 16 are joined by a pair of webs 102a, 102b which may be separated by tearing or cutting. The provision of a number of spring anchors 16 as part of a strip 100 advantageously permits their convenient delivery to a consumer or the automatic positioning and attachment of the spring anchors 16 by the use of a customized tool (not shown) which is adapted to automatically align and secure the spring anchors 16 in a desired position on a frame member 12.

FIG. 10 illustrates another embodiment of an anchor 16 in position secured to a frame member 12, and wherein like reference numerals are used to identify like components. In FIG. 10, the anchor 16 is used to couple a curved end coil 30 of a spring 14 to the frame member 12. To minimize any localized points of contact between the spring 14 and anchor 16, the lateral through-opening 58 is provided with rearwardly convex forwardmost wall portion 110 which has a curvature which substantially corresponds to the curvature of the coil 14. It is to be appreciated that with this configuration, any load forces applied by the spring 14 are evenly spread substantially across the lateral width of the loop portion 42.

Although the preferred embodiment of the invention describes the anchor clip 14 as being formed from extruded plastic, the invention is not so limited. The anchors 14 could also be formed from molded or cast plastics or metals, as well as from extruded metals such as aluminum.

While FIGS. 2 and 3 describe and illustrate a staple 64 as being used to secure the anchor to the frame members 12, the invention is not so limited. Other mechanical or even non-mechanical fasteners including glues and adhesives, could also be used. Suitable alternate fasteners would include without restriction, the use of screws, clips or, in the case where metal anchor members are to be secured to metal frame members by welding.

Although the preferred embodiment discloses the use of a hooked end 34 to assist in maintaining the spring coil 30 in the through-opening 58, other configurations to prevent removal of the spring 14 from the anchor 16 are also possible, including without restriction the use of flanges, crimped ends, rivets or pins.

Although the detailed description describes and illustrates various preferred embodiments, the invention is not so limited. Many modifications and variations will now occur to a person skilled in the art. For a definition of the invention, reference may be had to the appended claims.

We claim:

1. In combination, a furniture frame comprising a first frame member, a second frame member spaced forwardly a distance apart from the first frame member, an elongate spring extending in a longitudinal direction from a first end portion to a second end portion substantially between the first and second frame members, and a spring anchor for coupling the first end of the spring to the first frame member,
the anchor being secured to the first frame member and including a generally planar flange portion extending from a rearward end to a forward end spaced towards the second frame member, and a spring retaining loop portion at said forward end,
said loop portion including a laterally extending through-opening, the first end portion of the spring extending through the through-opening, and whereby the engagement of the first end portion of the spring with said loop portion substantially prevents the return movement of the first end portion outwardly therefrom.

2. The combination of claim 1 wherein said first end portion of said spring includes a hooked portion,
in a lateral cross-section said through-opening having a generally elliptical shape and having a length along its elongated axis selected marginally greater than a thickness of said hooked portion to enable the lateral sliding insertion of the first end portion through the through-opening when the hooked portion is aligned with the axis.

3. The combination of claim 2 wherein the through-opening has a width in a direction generally normal to its elongated axis which is selected greater than a diameter of the first end portion of the spring and less than the thickness of said hooked portion, and
wherein said axis is inclined at between about 10° and 45° relative to said planar flange portion.

4. The combination of claim 1 wherein said through-opening has a generally lateral cross-sectional shape selected from a circle, an ellipse, and a polygon.

5. The combination of claim 2 wherein said through-opening includes an enlarged diameter bevelled edge portion, said edgemost portion acting as a caming surface for guiding the initial placement of said first end of said spring into said through-opening.

6. The combination of claim 1 wherein said first frame member includes a generally planar top surface and a generally planar forward edge surface extending substantially normal to the top surface,
said loop portion further including a generally planar rearward facing edge,
said anchor being secured to said first frame member with a lower portion of said flange member in overlying juxtaposition with said top surface, and said rearward facing edge substantially in juxtaposed contact with said forward edge surface.

7. The combination of claim 6 wherein said second frame member includes a planar top surface which is substantially coplanar with the top surface of the first frame member, said through-opening having an elliptical cross-sectional shape elongated along an axis inclined at an angle of between about 30° relative to the plane of top surfaces of said first and second frame members.

8. The combination of claim 1 further including a mechanical fastener engaging each of said flange portion and said first frame member for securing said anchor against said top surface, said flange portion further including at least one guide rib for guiding the positioning of said fastener, said flange portion presenting an uppermost surface of said anchor, and said loop portion disposed intermediate said first and second frame members.

9. A spring anchor for use in securing a first end of a spring to a furniture frame member, the anchor comprising a generally P-shaped clip member including a flange portion having a forward end and a rearward end, and a spring retaining continuous loop portion integral with said forward end,
the rearward end including a planar lower surface adapted for juxtaposed contact with a mounting surface of said furniture frame,
said loop portion including a laterally extending through-opening sized to receive and retain the first end of the spring.

10. A spring anchor as claimed in claim 9 wherein said through-opening has an elliptical cross-sectional shape elongated along a longitudinally extending axis.

11. A spring anchor as claimed in claim 10 wherein said axis is inclined at an angle of about 30° relative to said planar surface, and wherein said anchor is formed as a plastic or aluminum extrusion.

12. A spring anchor as claimed in claim 11 wherein said anchor is provided as part of a strip of a plurality of anchors, each of said anchors having substantially the identical construction, and wherein immediately adjacent anchors of said strip are joined to each other at proximate side portions.

13. A spring anchor clip as claimed in claim 9 wherein said through-opening includes an enlarged diameter edgemost portion, said enlarged edgemost portion providing a caming surface for guiding the initial sliding insertion of said first end of said spring through said opening.

14. In combination, a seating frame member, an elongate spring having a first end portion and a second end portion, and a spring anchor for securing the first end portion of the spring to the frame member,
the spring anchor comprising a generally P-shaped clip member including a generally planar flange portion having a forward end and a rearward end, and a spring retaining continuous loop portion disposed at said forward end, the loop portion being integrally formed with the flange portion and defining a through-opening extending therethrough sized to receive and retain the first end portion of the spring.

15. The combination of claim 14 wherein said frame member includes a generally planar mounting surface, and said flange includes a planar lower surface, the anchor being secured to said frame member with the lower surface of the flange member substantially in overlying juxtaposition with said mounting surface.

16. The combination of claim 15 wherein said frame member includes a generally planar forward edge surface extending in an orientation substantially normal to the mounting surface, and
said loop portion includes a generally planar rearward shoulder extending in an orientation generally normal to the lower surface, wherein the anchor is secured to the frame member with the rearward shoulder substantially in juxtaposed contact with said forward edge surface.

17. The combination of claim 15 further including a second other frame member spaced from the seating frame member, the second other end of the spring being coupled to the second frame member, and wherein the loop portion extends a distance forwardly from the frame member in a direction towards the second other frame member.

18. The combination of claim 17 further including a mechanical fastener extending through said flange portion and engaging said frame member for fixedly securing said anchor to said frame member, and
wherein the through-opening is provided with a rearwardly convex forwardmost wall portion.

19. The combination of claim 17 wherein said mounting surface comprises a top surface of said seating frame, said flange includes a generally planar upper surface oriented substantially parallel to said lower surface, and said loop portion extends substantially in a direction downwardly from said upper surface.

20. The combination of claim 14 wherein the spring is a longitudinally elongated no-sag spring in which the first end portion extends generally in the lateral direction, and said seating frame is selected from the group consisting of a furniture seating frame, an airplane seating frame, an automotive or vehicle seating frame, and a rail car seating frame.

21. The combination of claim 19 wherein said through-opening has an elliptical cross-sectional shape elongated along an axis.

22. The combination of claim 21 wherein the axis is inclined relative to said upper surface at an angle selected at between 0° and 45° and includes a forward endmost bight, said bight having a radius of curvature substantially corresponding to a cross-sectional radius of curvature of said spring adjacent said first end.

23. The combination of claim 14 wherein said first end portion of said spring includes a hooked portion,
in a lateral cross-section said through-opening having a generally elliptical shape and having a length along its elongated axis selected marginally greater than a thickness of said hooked portion to enable the lateral sliding insertion of the first end portion through the through-opening when the hooked portion is aligned with the axis.

24. The combination of claim 23 wherein the through-opening has a width in a direction generally normal to its elongated axis which is selected greater than a diameter of the first end portion of the spring and less than the thickness of said hooked portion, and
wherein said axis is inclined at between about 10° and 45° relative to said planar flange portion.
